(19) United States
(12) Patent Application Publication
(10) Pub. No.: US 2009/0050005 A1
(43) Pub. Date: Feb. 26, 2009

(54) WEBBING A SUBSTRATE WEB INTO A WEB-FED ROTARY PRINTING PRESS

(75) Inventor: Josef Hammer, Plauen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/195,040

(22) Filed: Aug. 20, 2008

(30) Foreign Application Priority Data
Aug. 21, 2007 (DE) 10 2007 039 486.3

(51) Int. Cl. B41F 5/04

(52) U.S. Cl. 101/219

(57) ABSTRACT

An apparatus and method for webbing a substrate web into a web-fed rotary printing press is disclosed. A webbing apron has a first connecting section, which can be connected to a longitudinal end of the substrate web, and has a second connecting section, which can be connected to a webbing arrangement for the substrate web of the printing press. The webbing apron includes at least two webbing apron elements, each of which is assigned to one of at least two partial substrate webs of the substrate web for webbing the same, and has a connecting device, which connects the webbing apron elements to one another in such a way that the webbing apron elements can be separated from one another by a predetermined tensile force acting on the connecting device and resulting from a relative movement of the partial substrate webs relative to one another.

This application claims the priority of German Patent Document No. 10 2007 039 486.3, filed Aug. 21, 2007, the disclosure of which is expressly incorporated by reference herein.

### BACKGROUND AND SUMMARY OF THE INVENTION

The invention relates to webbing a substrate web into a web-fed rotary printing press, in particular a webbing apron for webbing a substrate web into a web-fed rotary printing press, a web-fed rotary printing press equipped with such a webbing apron and a method for webbing a substrate web into a web-fed rotary printing press using such a webbing apron.

Conventional webbing aprons for webbing a substrate web into a web-fed rotary printing press are known from German Patent Document No. DE 44 09 693 C1, which describes a device for webbing a substrate web via turner bars. With reference to FIG. 1, the partial substrate webs 1a, 1b formed from a single substrate 1 in a longitudinal cutting device 2, 3 using a cutting roller 2 and a cutting ring 3 are further fed into the press, whereby one of the partial substrate webs 1b continues further over turner bars 12, 13. The partial substrates 1a, 1b are fed into the web-fed rotary printing press by means of two separate webbing aprons which are mounted on the respective side bow chains. The side bow chains run over guides 5, 17.

A substrate web 1 which has been printed and/or is yet to be printed in a printing unit (not shown in FIG. 1) is fed over the cutting roller 2 into a turner bar nest and at the same time is cut as long as the cutting ring 3, which is adjustable on the cutting roller 2, severs the substrate web 1 in the longitudinal direction. This forms two partial substrate webs 1a and 1b from the substrate web 1.

The partial substrate web 1a also travels a straight path like the substrate web 1. The webbing apron 4, which is webbed from the roller chain running in the guide 5, webs the partial substrate web 1a exactly as it did substrate web 1 previously. However, the prerequisite for this is that the webbing apron 4 must not be wider at its widest point than the partial substrate web 1a, so that it is not cut by the cutting ring 3. The substrate web 1 is chamfered on its front end, so that overlapping cover pieces 6 on the rear end of the webbing apron 4 grip the front end of the substrate web 1 over a width of less than half and clamp it tightly by magnetic attraction between the two cover pieces 6.

If a substrate web 1 has just been webbed-in up to the turner bar nest, the cutting ring 3 is first stopped by the cutting roller 2. The webbing apron 7 which is provided for the partial substrate web 1b has cover pieces 8 containing a permanently magnetic material, like the cover pieces 6, and can clamp the front end of the partial substrate web 1b securely by magnetic attraction. The upper of the two cover pieces 8 “sticks” under a web 9, which is also magnetic before the start of the webbing of the partial substrate web 1b, while the lower cover piece 8 rests on a holder 10 arranged beneath the webbing path of the partial substrate web 1b such that the cover pieces 8 are not yet constricted before webbing the front end of the partial substrate web 1b to such an extent that they would collapse. On the other hand, the top cover piece 8 adheres to the sheet metal 9 with such a low magnetic force that it is pulled away from it with the onset of the pulling movement of the webbing apron 7, so that both of the cover pieces 8 collapse.

When a sensor 11 records the run-in of the substrate web 1, at the same time the cutting ring 3 is set at an angle on the cutting roller 2 and the webbing apron 7 is set in motion. Due to the fact that the partial substrate web 1a is not separated from the partial substrate 1b for a length L from the clamping area of the cover pieces 8 of the webbing apron to the cutting ring 3 as long as the sensor 11 does not deliver a corresponding signal for adjusting the cutting ring 3 to the cutting roller 2 and at the same time the webbing apron 7 has been set in motion, this achieves the result that the front end of the partial substrate web 1b is webbed in between the cover pieces 8 of the webbing apron 7. Only when the paths of the partial substrate webs 1a and 1b are separated does the intermediate piece that still connects the two partial substrate webs 1a and 1b between them tear.

The device described in DE 44 09 693 C1 and illustrated in FIG. 1 has some disadvantages which can have a negative influence on the operational reliability of the device. First, the “automatic” collapse of the two cover pieces 8 of the webbing apron 7 causes uncertainty in the webbing operation because it is impossible to rule out entirely that the two cover pieces 8 do not collapse “automatically” with a pulling movement of the webbing apron 7 and the partial substrate web 1b is not clamped. Secondly, the force required to separate the two partial substrate webs 1a, 1b depends first on the length L and secondly on the quality of the substrate so that this force may vary. However, if the separating force is too great, it can have a negative effect on the webbing process and may even lead to separation of one of the webbing aprons 4, 7 from its partial substrate web 1a and/or 1b.

The object of the present invention is to provide a webbing apron for webbing a substrate web into a web-fed rotary printing press which is easy to handle and to ensure a greater operating reliability in the webbing operation. Furthermore, the invention is based on the object of providing a web-fed rotary printing press equipped with such a webbing apron and a method for webbing a substrate web into a web-fed rotary printing press using the inventive webbing apron.

According to the invention, a webbing apron is provided for webbing up a substrate web into a web-fed rotary printing press, whereby the substrate web is to be separated into at least two partial substrate webs in a longitudinal cutting device of the web-fed rotary printing press and whereby the webbing apron has a first connecting section which can be connected to a longitudinal end of the substrate web and a second connecting section that can be connected to a webbing arrangement for the substrate web of the web-fed rotary printing press. The inventive webbing apron is characterized in that the webbing apron has as least two webbing apron elements, each being assigned to one of the at least two partial substrate webs for webbing up the latter, and has a connecting device which connects the webbing apron elements to one another in such a way that the webbing apron elements can be separated from one another by a predetermined tensile force acting on the connecting device, resulting from a relative movement of the partial substrate webs.

According to a further embodiment of the invention, the connecting device is equipped in such a way that when the web guidance paths of the two partial substrate webs are separated in the web-fed rotary printing press, the webbing apron elements can be separated from one another by the tensile force acting on the connecting device.

According to the invention, the webbing apron elements each have a first end and a second end, whereby the first ends of the webbing apron elements form the first connecting section and the second ends of the webbing apron elements form the second connecting section.

Due to the fact that the webbing apron with its first connecting section can be connected to the longitudinal end of the substrate web and with its second connecting section can be connected to the webbing arrangement for the substrate web, whereby the two webbing apron element are joined together by means of the connecting device, the substrate web and/or the partial substrate webs may always be webbed up reliably into the web-fed rotary printing press. The substrate web may be separated into the partial substrate webs beginning at its longitudinal end, so that the force required for separating the partial substrate webs is determined only by the configuration of the connecting device. This achieves a high operating reliability for the webbing operation and simple handing of the webbing apron.

According to a further embodiment of the invention, the first ends of the webbing apron elements are arranged in such a way that they can each be connected to a longitudinal end section of each respective partial substrate web.

In this way, the simple and reliable handling of the inventive webbing apron is additionally supported in an advantageous manner.

According to a further embodiment of the invention, the second ends of the webbing apron elements are arranged in such a way that they can each be connected to a respective webbing arrangement for the substrate web of a plurality of webbing devices, and whereby the respective webbing devices are provided for webbing the respective partial substrate webs.

With this embodiment of the present invention, a webbing device may be assigned to each webbing apron element and/or each partial substrate web in a simple and reliable manner, implementing the webbing of the partial substrate web along its desired web guidance path. The webbing device may have a towing chain for coupling and pulling the respective webbing apron element and a guide for guiding the towing chain along the respective web guidance path, as described in DE 44 09 693 C1.

According to a further embodiment of the invention, the first ends of the webbing apron elements each have a magnetic closure for joining the respective webbing apron elements to the longitudinal end section of each respective one of the partial substrate webs.

Thus the webbing apron elements may be connected to the longitudinal end sections of the partial substrate webs quickly, reliably and in a reusable manner, so that setup time and cost for the webbing aprons can be eliminated.

According to further embodiments of the invention, the connecting device is formed by a hook-and-loop closure or a magnetic closure.

With these embodiments of the invention, it is possible to easily and quickly join two webbing apron elements together, whereby the course required to separate the webbing apron elements can be predetermined reliably by the design of the hook-and-loop closure and/or the magnetic closure. Furthermore, after successfully webbing the partial substrate webs, the webbing apron elements can be joined together again by means of the hook-and-loop closure and/or the magnetic closure, so that the inventive webbing apron is reusable.

According to the invention, a web-fed rotary printing press has a webbing arrangement for the substrate web for webbing a substrate web into the web-fed rotary printing press, a longitudinal cutting device for separating the substrate web into at least two partial substrate webs and a webbing apron with a first connecting section that can be connected to a longitudinal end of the substrate web, and with a second connecting section that can be connected to the webbing arrangement for the substrate web. The webbing arrangement for the substrate web has a first webbing device for webbing one of the at least two partial substrate webs and a second webbing device for webbing the other of the at least two partial substrate webs. The web-fed rotary printing press is characterized in that the webbing apron has at least two webbing apron elements, each being assigned to one of the at least two partial substrate webs for webbing them in and a connecting device which connects the webbing apron elements to one another, such that the webbing apron elements can be separated from one another by a predetermined tensile force which results from a movement of the partial substrate webs relative to one another and acts on the connecting device.

According to a further embodiment of the invention, the connecting device is set up in such a way that when the web guidance paths of the two partial substrate webs are separated in the web-fed rotary printing press, the webbing apron elements can be separated from one another due to the tensile force acting on the connecting device.

According to a further embodiment of the invention, the first webbing device is arranged on an operator side of the web-fed rotary printing press and the second webbing device is arranged on a drive side of the web-fed rotary printing press.

In this way, two partial substrate webs can be webbed-in easily and reliably along different web guidance paths into the web-fed rotary printing press.

According to a further embodiment of the invention, the webbing apron elements each have a first end and a second end, such that the first ends of the webbing apron elements form the first connecting section and the second ends of the webbing apron elements form the second connecting section.

Due to the fact that the webbing apron elements can be connected at their first end to the longitudinal end of the substrate web and can be connected at their second end to one of the webbing devices, such that the two webbing apron elements can be connected to one another by means of the connecting device, the substrate web and/or the partial substrate webs can always be reliably webbed into the web-fed rotary printing press. The substrate web can be separated into the partial substrate webs beginning at its longitudinal end so that the required force for separating the partial substrate webs is determined only by the configuration of the connecting device. A high operating reliability for the webbing operation and simple handling of the web-fed rotary printing press are thus achieved.

According to a further embodiment of the invention, the first ends of the webbing apron elements are arranged in such a way that they can each be connected to a longitudinal end section of one of the assigned partial substrate webs.

In this way, simple and reliable handling of the inventive web-fed rotary printing press is additionally supported in an advantageous manner.

According to a further embodiment of the invention, the second ends of the webbing apron elements are arranged in such a way that they can be connected to the webbing device for the respective partial substrate web.

With this embodiment of the invention, a webbing device which implements the webbing of the partial substrate web along its desired web guidance path can be assigned to each webbing apron element and/or each partial substrate web in a simple and reliable manner. As described in DE 44 09 693 C1, the webbing device may have a towing chain for coupling and pulling the respective webbing apron element and a guide for guiding the towing chain along the respective web guidance path.

According to a further embodiment of the invention, the first ends of the webbing apron elements each have a magnetic closure for connecting the respective webbing apron elements to the longitudinal end section of each of the respective partial substrate webs.

The webbing apron elements can thus be connected to the longitudinal end sections of the partial substrate webs in a rapid, reliable and reusable manner, so that setup time and cost of webbing aprons can be saved.

According to further embodiments of the invention, the connecting device is formed by a hook-and-loop closure or a magnetic closure.

With these embodiments of the inventive web-fed rotary printing press, it is possible in a simple and rapid manner to connect two webbing apron elements to one another, such that the force required for separating the webbing apron elements can be predetermined reliably by the design of the hook-and-loop closure and/or the magnetic closure. Furthermore, the webbing apron elements can be joined together again by means of the hook-and-loop closure and/or the magnetic closure after successful webbing-in of the partial substrate webs, so that the inventive webbing apron is reusable.

According to the invention, a method for webbing a substrate web into a web-fed rotary printing press using a webbing apron according to one of the embodiments described above has the following steps: providing a substrate web which has a longitudinal edge and which is to be separated in the web-fed rotary printing press into at least two partial substrate webs, joining together the webbing apron elements by means of the connecting device of the webbing apron, connecting the first connecting section of the webbing apron to the longitudinal end of the substrate web so that at least two webbing apron elements are each assigned to one of the at least two partial substrate webs for webbing them in, connecting the second connecting section of the webbing apron to a first webbing device on a first side of the web-fed rotary printing press for webbing one of the at least two partial substrate webs and to a second webbing device on a second side of the web-fed rotary printing press for webbing the other of the at least two partial substrate webs, webbing the substrate web into the web-fed rotary printing press up to a separation position at which the web guidance paths of the partial substrate webs are separated, separating the substrate web into the partial substrate webs by means of a longitudinal cutting device of the web-fed rotary printing press arranged upstream from the separation position in the direction of travel of the web as soon as the longitudinal end of the substrate web has reached the longitudinal cutting device, so that the substrate web is separated starting from its longitudinal end, further webbing of the separate partial substrate webs into the web-fed rotary printing press such that the partial substrate webs are passed through the web-fed rotary printing press over different web guidance paths, so that the webbing apron elements are separated from one another by a predetermined tensile force acting on the connecting device, resulting from the different web guidance paths of the partial substrate webs.

Due to the fact that the webbing apron elements are connected at their first end to the longitudinal end of the substrate web and are connected at their second end to one of the webbing devices, such that the two webbing apron elements are connected to one another by means of the connecting device, the substrate web and/or the partial substrate webs may each always be reliably webbed into the web-fed rotary printing press. According to the invention, the substrate web may be separated into the partial substrate webs beginning at its longitudinal end so that the force required for separating the partial substrate webs is determined only by the configuration of the connecting device. Thus a high operating reliability for the webbing process and simple handling of the webbing apron and/or the web-fed rotary printing press are achieved.

In other words, the web-fed rotary printing press (at least downstream from the nipper roller upstream from the turner bar) has a webbing device on the operator side and has a webbing device on the drive side of the web-fed rotary printing press. The webbing apron is two parts and is held together at the center by an openable/reclosable closure (advantageously a hook-and-loop closure or a magnetic closure). The cutting blade sits on the substrate web after passing through the webbing apron. As soon as the paths diverge from the straight-ahead line (partial substrate web not to be turned) and turner bar (partial substrate web to be turned), the closure is ripped open and the two halves of the substrate web are webbed-in. After conclusion of the webbing operation, the two halves of the webbing apron are joined together again.

With the inventive web-fed rotary printing press, even the turner bar can thus be webbed in automatically in a reliable manner without the webbing operation having to be interrupted and the turner bar optionally having to be mounted manually. This is the case especially with web-fed rotary printing presses having a vertical turn in an advantageous manner and significantly decreases the amount of time required to prepare for production.

The invention is explained in greater detail below on the basis of an embodiment and with reference to the accompanying figures.

### BRIEF DESCRIPTION OF THE DRAWINGS

FIG. 1 shows a device for webbing substrate webs over turner bars according to the state of the art.

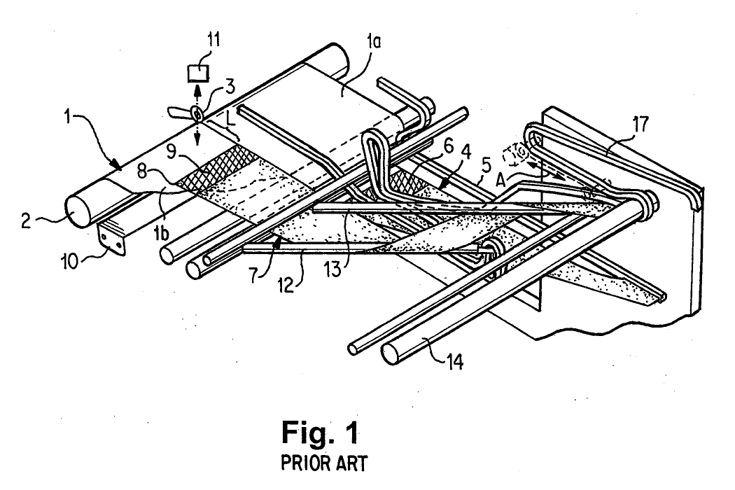

FIG. 2 shows a schematic partial view of an inventive web-fed rotary printing press, whereby the webbing apron according to one embodiment of the invention is connected to the webbing arrangement for the substrate web and the substrate web.

FIG. 3 shows a schematic view of a first webbing apron element of the inventive webbing apron.

FIG. 4 shows a schematic view of a second webbing apron element of the inventive webbing apron.

FIG. 5 shows a schematic view illustrating how the substrate web is separated into two partial substrate webs in webbing-in a substrate web by means of the inventive webbing apron, whereby one of the two partial substrate webs is turned by means of a turner bar arrangement onto the other of the two partial substrate webs.

FIG. 6 shows a flow chart of the inventive method for webbing a substrate web into a web-fed rotary printing press.

### DETAILED DESCRIPTION OF THE DRAWINGS

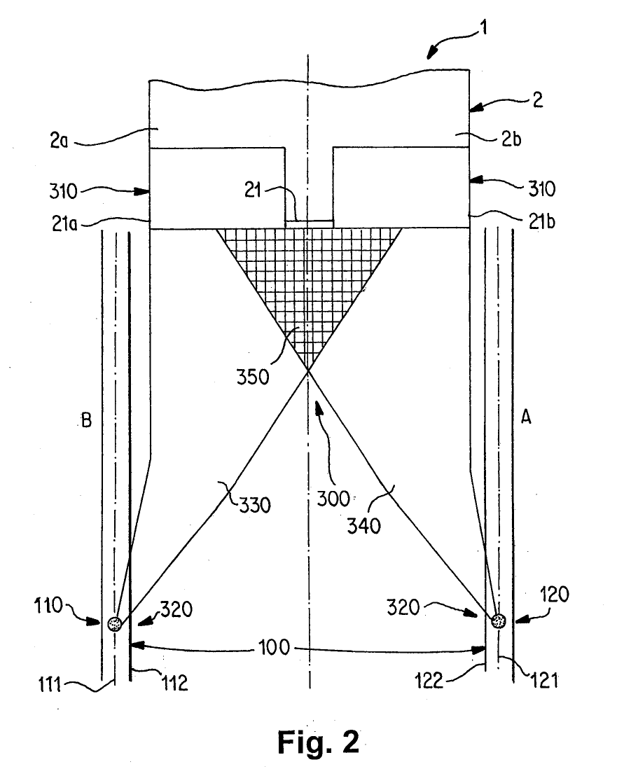

The embodiment of the invention is now described in greater detail below with reference to FIGS. 2 through 6.

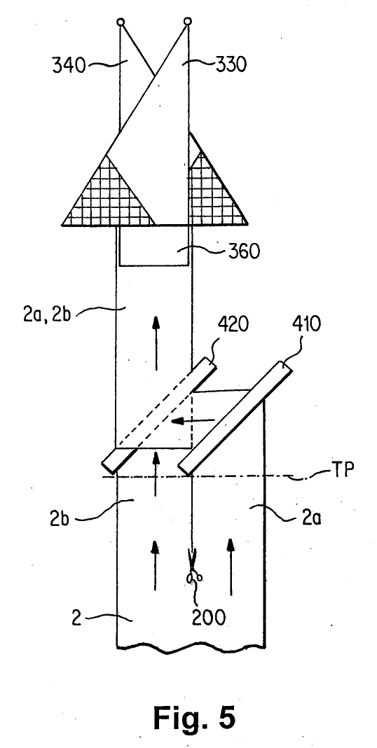

As shown in FIG. 2 and FIG. 5 in particular, an inventive (not shown completely in FIG. 2) web-fed rotary printing press 1 (hereinafter simply printing press) includes a webbing arrangement for the substrate web 100 for webbing a substrate web 2 into the printing press 1, a longitudinal cutting device 200 (shown in FIG. 5) for separating the substrate web 2 into two partial substrate webs 2a, 2b and a webbing apron 300 having a first connecting section 310, which is connected to a longitudinal end 21 of the substrate web 2 and a second connecting section 320, which is connected to the webbing arrangement for the substrate web 100. The webbing arrangement for the substrate web 100 has a first webbing device 110 for webbing the one partial substrate web 2a and a second webbing device 120 for webbing the other partial substrate web 2b.

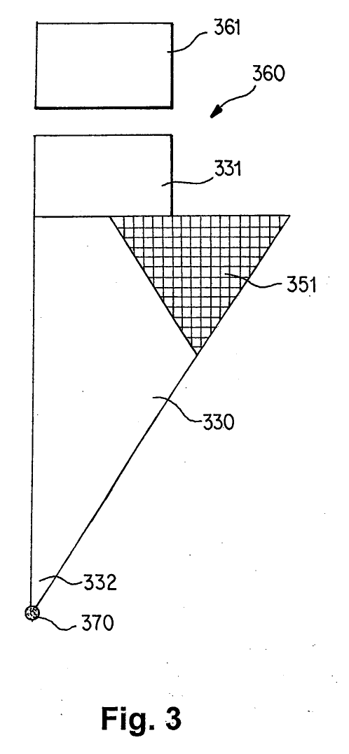

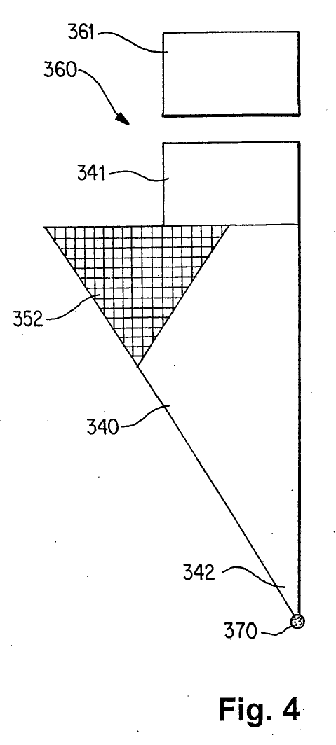

As shown in FIG. 2, FIG. 3 and FIG. 4 in particular, the webbing apron 300 has two webbing apron elements 330 and 340, whereby the webbing apron element 330 of the partial substrate web 2a is assigned to the latter for webbing the same and the webbing apron element 340 is assigned to the partial substrate web 2b for webbing the same and it has a connecting device 350 which connects the webbing apron elements 330, 340 to one another in such a way that the webbing apron elements 330, 340 can be separated from one another by a predetermined tensile force acting on the connecting device 350, resulting from a relative movement of the partial substrate webs 2a, 2b relative to one another.

The webbing apron elements 330, 340 are each designed as flat and flexible plastic strips.

According to this embodiment of the invention, the connecting device 350 is set up in particular so that when the web guidance paths of the two partial substrate webs 2a, 2b (see FIG. 5) diverge in the printing press 1, the webbing apron elements 330, 340 can be separated from one another by the tensile force acting on the connecting device 350. In other words, the connecting device 350 is configured so that when the partial substrate web 2a is turned by means of an arrangement of turner bars 410, 420 provided in the printing press 1 onto the partial substrate web 2b (see FIG. 5), the webbing apron elements 330, 340 are separated from one another by the tensile force acting on the connecting device 350.

According to this embodiment of the invention, the connecting device 350 is formed by a hook-and-loop closure. In other words, the webbing apron element 330 has a connecting strap 351 which is provided with hook elements on one side and the webbing apron element 340 has a connecting strap 352 which is provided with loop elements on one side. The hook elements and the loop elements are formed on respective nylon strips which are applied to the lateral surfaces of the connecting straps 351 and 352 in such a way that they are opposite one another. In joining the webbing apron elements 330, 340 to one another, the two connecting straps 351, 352 are placed on top of one another, as illustrated in FIG. 2, so that the hook elements become engaged with the loop elements.

The surface dimension of the nylon strips and the design of the hook elements and the loop elements are selected so that the nylon strip and/or the connecting straps 351, 352 are separated from one another by the tensile force acting on the connecting straps 351, 352 when the partial substrate web 2a is turned onto the partial substrate web 2b by means of the arrangement of turner bars 410, 420 provided in the printing press 1.

As shown in FIG. 3 and FIG. 4 in particular, the webbing apron elements 330 and 340 each have a first end 331 and/or 341 and a second end 332 and/or 342, such that the first ends 331, 341 of the webbing apron elements 330, 340 form the first connecting section 310, and the second ends 332, 342 of the webbing apron elements 330, 340 form the second connecting section 320.

As shown in FIG. 2 in particular, the first ends 331, 341 of the webbing apron elements 330, 340 are arranged in such a way that they can each be connected to a longitudinal end section 21a and/or 21b of one of the assigned partial substrate webs 2a and 2b.

According to this embodiment of the invention, the first ends 331, 341 of the webbing apron elements 330 and 340 each have a magnetic closure 360 for connecting the respective webbing apron elements 330 and 340 to the longitudinal end section 21a and/or 21b of the respective partial substrate web 2a and/or 2b.

The magnetic closures 360 are formed by the respective first ends 331, 341 of the webbing apron elements 330, 340 and the respective cover plates 361, whereby the first ends 331, 341 as well as the cover plates 361 are permanently magnetic so that they mutually attract one another magnetically. When joining the first ends 331, 341 to the longitudinal end sections 21a, 21b of the partial substrate webs 2a, 2b, the first ends 331, 341 are placed on one side of the longitudinal end sections 21a, 21b as shown in FIG. 2 and the cover plates 361 are placed on the other side of the longitudinal end sections 21a, 21b. Therefore, each longitudinal end section 21a, 21b is arranged between a first end 331, 341 and a cover plate 361 such that the respective first end 331, 341, and cover plate 361 attract one another magnetically and therefore securely clamp the respective longitudinal end section 21a, 21b between them.

As also shown in FIG. 2, the first webbing device 110 is arranged on an operator side B of the printing press 1 and has a towing chain 111 for coupling and pulling the webbing apron element 330 and the guide 112 for guiding the towing chain 111 along the web guidance path of the partial substrate web 2a. The second webbing device 120 is arranged on a drive side A of the printing press 1 and has a towing chain 121 for connecting and pulling the webbing apron element 340 and has a guide 122 for guiding the towing chain 121 along the web guidance path of the partial substrate web 2b.

As shown in FIG. 3 and FIG. 4, the webbing apron elements 330, 340 each have a coupling device 370 on their second ends 332, 342 for coupling to the towing chain 111 and/or 121. According to this embodiment of the invention the coupling device 370 is formed by a ball which can be hung in the towing chains 111, 121.

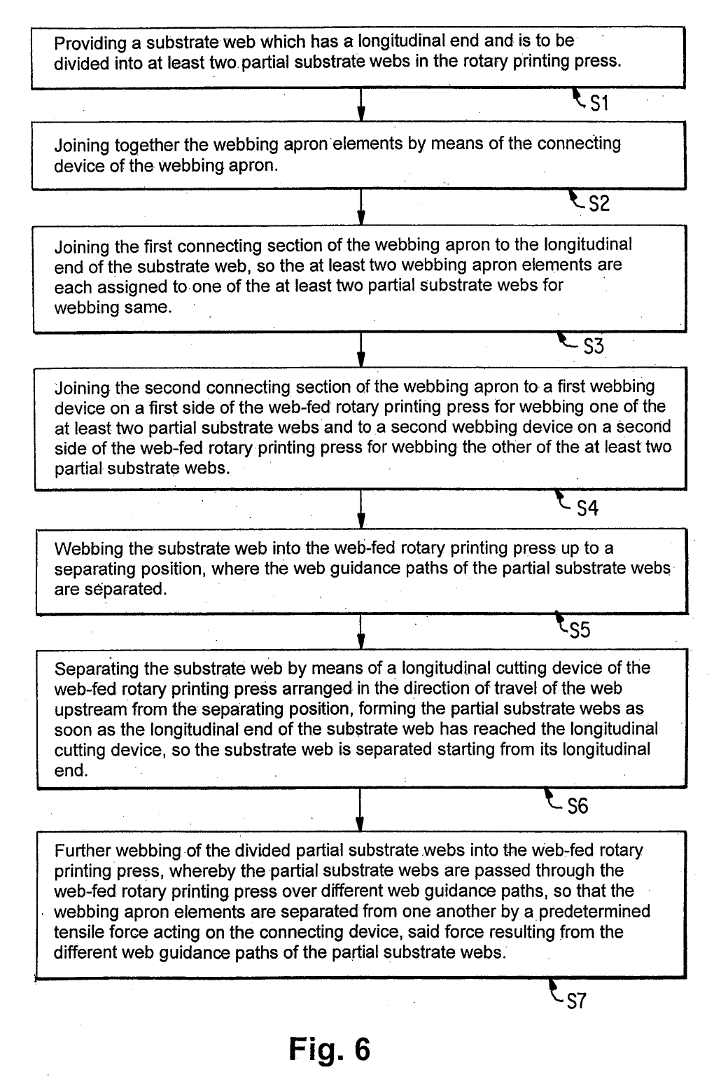

Now with reference to FIG. 2, FIG. 5 and FIG. 6, an inventive embodiment of the method for webbing a substrate 1 into a printing press using the inventive webbing apron 300 is described.

When a new substrate web 2 which is to be separated into the two partial substrate webs 2a, 2b in the printing press 1, is to be webbed into the press, in a step S1 a new substrate web 2 is provided.

In a step S2, the webbing apron elements 330, 340 are joined together by means of the connecting device 350 of the webbing apron 300.

In a step S3 the first connecting section 310 of the webbing apron 300 is connected to the longitudinal end 21 of the substrate web 2 so that two webbing apron elements 330, 340 are each assigned to one of the two partial substrates 2a, 2b for webbing the same. In other words, in step S3 the first end 331 of the webbing apron element 330 is connected to the longitudinal end section 21a of the substrate web 2 and the first end 341 of the webbing apron element 340 is connected to the longitudinal end section 21b of the substrate web 2.

In a step S4, the second connecting section 320 of the webbing apron 300 is connected to the first webbing device 110 on the operator side B of the printing press 1 for webbing the partial substrate web 2a and is connected to the second webbing device 120 on the drive side of the printing press 1 for webbing the partial substrate web 2b. In other words, in step S4 the coupling device 370 is coupled to the towing chain 111 of the first webbing device 110 on the second end 332 of the webbing apron element 330 and the coupling device 370 is coupled to the towing chain 121 of the second webbing device 120 on the second end 342 of the webbing apron element 340.

In a step S5, the substrate web 2 is webbed into the printing press 1 up to a separation position TP, where the web guidance paths of the partial substrate webs 2a, 2b are separated (see FIG. 5). More specifically, the webbing apron 300 is webbed into the printing press 1 to such an extent that the webbing apron elements 330, 340 are still separated by the tensile force resulting from the different web guidance paths of the partial substrate webs 2a, 2b.

In a step S6, the substrate web 2 is separated into the partial substrate webs 2a, 2b by means of the longitudinal cutting device 200 of the printing press 1 arranged in the direction of travel of the web upstream from the separation position TP as soon as the longitudinal end 21 of the substrate web 2 has reached the longitudinal cutting device 200 so that the substrate web 2 is separated, beginning at its longitudinal end 21.

In a step S7, the partial substrate webs 2a, 2b which have been separated from one another are webbed further into the printing press 1, such that the partial substrate webs 2a, 2b are passed over different web guidance paths through the printing press 1, so that the webbing apron elements 330, 340 are separated from one another by the predetermined tensile force acting on the connecting device 350, the tensile force resulting from the different web guidance paths of the partial substrate webs 2a, 2b.

In other words, according to this embodiment of the invention, the partial substrate web 2a is turned by means of the turner bars 410, 420 onto the partial substrate web 2b in step S7, such that the connecting device 350 is separated from the webbing apron 300 on the first turner bar 410 in the direction of travel of the web. Due to the webbing apron elements 330, 340 which are now separated from one another, the two partial substrate webs 2a, 2b can be webbed further into printing press 1 independently of one another.

As can be seen from the preceding description of the invention, it is possible with the inventive webbing apron to web a substrate web easily and reliably into a web-fed rotary printing press 1.

Due to the fact that the two webbing aprons 330, 340 of the inventive webbing apron 300 are connected to the substrate web 2 from the beginning, a more uniform and more reliable webbing of the substrate web 2 is ensured, because a better distribution of force on the substrate web 2 is possible.

Due to the fact that the substrate web 2 is separated by means of the longitudinal cutting device 200 from the beginning of its longitudinal end 21 upstream from the separation position TP, the tensile force required for separating the webbing apron elements 330, 340 is determined only by the configuration of the connecting device 350 and therefore can be adapted in a defined manner. In other words, the tensile force required for separating the webbing apron elements 330, 340 is not subject to any great fluctuations, so the webbing operation is reliable.

### LIST OF REFERENCE NUMERALS

1 web-fed rotary printing press (abbreviated: printing press)
2 substrate web
2a partial substrate web
2b partial substrate web
21 longitudinal end
21a longitudinal end section
21b longitudinal end section
100 webbing arrangement for the substrate web
110 first webbing device
11 towing chain
112 guidance
120 second webbing device
121 towing chain
122 guidance
200 longitudinal cutting device
300 webbing apron
310 first connection section
320 second connection section
330 webbing apron element
331 first end
332 second end
340 webbing apron element
341 first end
342 second end
350 connecting device
351 connecting strap
352 connecting strap
360 magnetic closure
361 cover plate
370 coupling device
410 turner bar
420 turner bar

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A webbing apron for webbing a substrate web into a web-fed rotary printing press, such that the substrate web is separated into at least two partial substrate webs in a longitudinal cutting device of the web-fed rotary printing press, wherein the webbing apron has a first connecting section, which is connectable to a longitudinal end of the substrate web, and has a second connecting section, which is connectable to a webbing arrangement for the substrate web of the web-fed rotary printing press, wherein the webbing apron has at least two webbing apron elements, each webbing apron element being assigned to one of the at least two partial substrate webs for webbing a respective partial substrate web, and a connecting device which connects the webbing apron elements to one another such that the webbing apron elements are separable from one another by a predetermined tensile force acting on the connecting device and resulting from a relative movement of the partial substrate webs relative to one another.

2. The webbing apron according to claim 1, wherein the connecting device is configured such that the webbing apron elements are separable from one another by the tensile force acting on the connecting device when web guidance paths of the two partial substrate webs are separated in the web-fed rotary printing press.

3. The webbing apron according to claim 1, wherein the webbing apron elements each have a first end and a second end and wherein the first end of the webbing apron elements forms the first connecting section and the second end of the webbing apron elements forms the second connecting section.

4. The webbing apron according to claim 3, wherein the first end of the webbing apron elements is arranged such that the first end is connectable to a longitudinal end section of a respective one of the partial substrate webs.

5. The webbing apron according to claim 3, wherein the second end of the webbing apron elements is arranged such that the second end is connectable to a respective one of a plurality of webbing devices of the webbing arrangement for the substrate web and wherein the respective webbing devices are provided for webbing of the respective partial substrate webs.

6. The webbing apron according to claim 4, wherein the first end of the webbing apron elements each have a magnetic closure for connecting the respective webbing apron elements to the longitudinal end section of the respective one of the partial substrate webs.

7. The webbing apron according to claim 1, wherein the connecting device is formed by a hook and loop closure.

8. The webbing apron according to claim 1, wherein the connecting device is formed by a magnetic closure.

9. A web-fed rotary printing press, comprising:
a substrate webbing arrangement for webbing a substrate web into the web-fed rotary printing press;
a longitudinal cutting device for separating the substrate web into at least two partial substrate webs; and
a webbing apron having a first connecting section which is connectable to a longitudinal end of the substrate web, and having a second connecting section which is connectable to the webbing arrangement for the substrate web;
wherein the webbing arrangement for the substrate web has a first webbing device for webbing one of the at least two partial substrate webs and a second webbing device for webbing an other of the at least two partial substrate webs;
and wherein the webbing apron has at least two webbing apron elements each being assigned to one of the at least two partial substrate webs for webbing the at least two partial substrate webs, and having a connecting device which connects the webbing apron elements to one another such that the webbing apron elements are separable from one another by a predetermined tensile force which acts on the connecting device and results from a relative movement of the partial substrate webs relative to one another.

10. The web-fed rotary printing press according to claim 9, wherein the connecting device is configured such that the webbing apron elements are separable from one another by the tensile force acting on the connecting device when web guidance paths of the two partial substrate webs are separated in the web-fed rotary printing press.

11. The web-fed rotary printing press according to claim 9, wherein the first webbing device is arranged on an operator side of the web-fed rotary printing press and wherein the second webbing device is arranged on a drive side of the web-fed rotary printing press.

12. The web-fed rotary printing press according to claim 9, wherein the webbing apron elements each have a first end and a second end and wherein the first end of the webbing apron elements forms the first connecting section and the second end of the webbing apron elements forms the second connecting section.

13. The web-fed rotary printing press according to claim 12, wherein the first end of the webbing apron elements is arranged such that the first end is connectable to a longitudinal end section of a respective partial substrate web.

14. The web-fed rotary printing press according to claim 12, wherein the second end of the webbing apron elements is arranged such that the second end is connectable to the webbing device for a respective partial substrate web.

15. The web-fed rotary printing press according to claim 13, wherein the first end of the webbing apron elements has a magnetic closure for connecting the webbing apron elements to the longitudinal end section of the respective partial substrate web.

16. The web-fed rotary printing press according to claim 9, wherein the connecting device is formed by a hook-and-loop closure.

17. The web-fed rotary printing press according to claim 9, wherein the connecting device is formed by a magnetic closure.

18. A method for webbing a substrate web into a web-fed rotary printing press using a webbing apron, comprising the steps of:
providing a substrate web which has a longitudinal end and which is to be separated in the web-fed rotary printing press into at least two partial substrate webs;
joining webbing apron elements of the webbing apron together by a connecting device of the webbing apron;
connecting a first connecting section of the webbing apron to the longitudinal end of the substrate web such that at least two webbing apron elements are each assigned to a respective one of the at least two partial substrate webs;
connecting a second connecting section of the webbing apron to a first webbing device on a first side of the web-fed rotary printing press for webbing one of the at least two partial substrate webs and to a second webbing device on a second side of the web-fed rotary printing press for webbing an other of the at least two partial substrate webs;
webbing the substrate web into the web-fed rotary printing press up to a separating position at which web guidance paths of the at least two partial substrate webs are separated;
separating the substrate web by a longitudinal cutting device of the web-fed rotary printing press arranged in a direction of travel of the substrate web upstream from the separating position, forming the at least two partial substrate webs as soon as the longitudinal end of the substrate web has reached the longitudinal cutting device so that the substrate web is separated starting from its longitudinal end; and
further webbing the at least two partial substrate webs into the web-fed rotary printing press wherein the two partial substrate webs are passed over different web guidance paths through the web-fed rotary printing press such that the webbing apron elements are separated from one another by a predetermined tensile force which acts on the connecting device and results from the different web guidance paths of the two partial substrate webs.
